(19) United States
(12) Patent Application Publication
(10) Pub. No.: US 2004/0170824 A1
(43) Pub. Date: Sep. 2, 2004

(54) Article having a no-slip surface and method of applying same

(75) Inventor: Ronald Thiemann, Cincinnati, OH (US)

Correspondence Address: Mark F. Smith, Suite 102, 7577 Central Park Boulevard, Mason, OH, 45040, US

(73) Assignee: Knittel Engraving Co. Inc., Miamitown, OH (US)

(21) Appl. No.: 10/795,042

(22) Filed: Mar. 5, 2004

Related U.S. Application Data
(63) Continuation-in-part of application No. 09/952,393, filed on Sep. 14, 2001, now Pat. No. 6,740,355.

(51) Int. Cl. B32B 27/00

(52) U.S. Cl. 428/327; 427/208.8; 428/323

(57) ABSTRACT

The present direction is directed to an article having a surface which operates as a substrate for receiving a no-slip surface or surface treatment and a method of applying the no-slip surface to the article. In a preferred embodiment of the invention, the no-slip surface is formed from a static cling material. In another preferred embodiment of the invention, a conventional thermographic powder, such as a granular thermoplastic resin, deposited along a surface of the static cling material. The powdered substrate is then subjected to heat sufficient to melt or soften the powder and adhere it onto the static cling material.

### CROSS-REFERENCE TO RELATED APPLICATION

This is a continuation-in-part of application Ser. No. 09/952,393, filed on Sep. 14, 2001 and deals with related subject matter.

### BACKGROUND OF THE INVENTION

The subject invention is direct to an article having a no-slip surface or surface treatment and, more particularly, to an article having a surface effective for reducing or preventing the article from sliding along a support or secondary surface and a method of applying the surface or surface treatment to the article.

There is a large demand for no-slip surfaces or surface treatments for providing a no-slip surface for a variety of articles. Such demand is especially high for surfaces that can provide a non-slip coefficient of friction while not detrimentally detracting from the appearance of the article. Such articles include, but are not limited to, trays, tray supports, coasters, beverage and food containers, tool handles, and the like. No-slip surfaces have also been used for various tools, such as tools used for measuring or cutting which incorporate the non-slip surface to enable a user to maintain the tool in position during operation.

While numerous no-slip surfaces and surface treatments are known, it has been found that they are often difficult to apply to certain substrate materials, or do not provide an attractive appearance thereby making them unacceptable for many applications. In addition, some applications often require that the no-slip surface be clear or transparent after they are applied to an article. Other materials, such as various types of plastic, such as urethane, while acceptable for certain no-slip surface applications, are relatively expensive and are often cost prohibitive for many applications. Further, many no-slip surfaces typically are difficult to attach to certain substrates due to adhesion difficulties and the potential for foreign material contamination.

Accordingly, a need exists for a no-slip surface or surface treatment for an article that can provide a non-slip coefficient of friction, that can be permanently or temporarily attached to the article, that can be clear or transparent, that is easily applied, does not detrimentally detract from the appearance of the article, and which is relatively cost effective for most applications.

### SUMMARY OF THE INVENTION

The present invention is directed to an article having a no-slip surface or surface treatment.

In another preferred embodiment of the present invention, the article comprises a measuring device.

In another preferred embodiment of the present invention, the measuring device is a ruler for use in measuring fabric for cutting.

In another preferred embodiment of the present invention, the article comprises flooring and the like.

In another preferred embodiment of the present invention, the article comprises a counter top, table top, and the like.

In another preferred embodiment of the invention, the article comprises bathroom fixtures, such as tubs, shower stalls, and the like.

In another preferred embodiment of the present invention, the article comprises a container such as a beverage or food container.

In another preferred embodiment of the present invention, the article comprises a tray.

In another preferred embodiment of the present invention, the article comprises a tray table.

In another preferred embodiment of the present invention, the article comprises a food container for the feeding of animals.

In another preferred embodiment of the present invention, the article comprises a sheet of static cling material.

In another preferred embodiment of the present invention, the no-slip surface comprises a fused thermographic powder.

In another preferred embodiment of the present invention, the thermographic powder forms a clear or transparent surface.

In another preferred embodiment of the invention, the thermographic powder comprises colored pigment to form a colored or a colored transparent surface.

In another preferred embodiment of the present invention, the no-slip surface is formed utilizing a thermographic process.

Another preferred embodiment of the invention is a method of applying a no-slip surface or surface treatment utilizing a thermographic process.

In another preferred embodiment of the present invention, the thermographic process comprises the step of selecting the roughness of the no-slip surface which produces the desired surface coefficient of friction and heating the thermographic powder to the proper temperature and for the proper amount of time to form the no-slip surface having the desired surface coefficient of friction.

Another preferred embodiment of the invention the no-slip surface can be easily removed.

Another preferred embodiment of the invention the no-slip surface is removable and comprises a static cling material.

A primary object of this invention, therefore, is to provide an article having a no-slip surface or surface treatment.

Another primary object of the invention is to provide an article having a no-slip surface which can be attached to a variety of substrate materials.

Other objects and advantages of the invention will be apparent from the following description, the accompanying drawings and the appended claims.

### BRIEF DESCRIPTION OF THE DRAWINGS

FIG. 1 is a partial perspective side view of an article of the subject invention having a surface for providing a substrate for receiving a no-slip surface;

FIG. 2 is a schematic showing the process steps of forming a no-slip surface;

FIG. 3 is a bottom plan view of the article of FIG. 1, wherein the article being a measuring device;

FIG. 4 is a bottom perspective view of the article of FIG. 1 wherein the article being a coaster or tray having a no-slip surface applied to its lower face;

FIG. 5 is a top plan of the article of FIG. 1 wherein the article being a tray support having a no-slip surface applied to its upper face;

FIG. 6 is a side elevation view of the article of FIG. 1 wherein the article being a container and having a no-slip surface applied to the outer face of its vertically extending wall and to its bottom surface;

FIG. 7 is another preferred embodiment of the invention showing an article having a surface for performing as a substrate for receiving a no-slip surface or surface treatment formed from a static cling material; and

FIG. 8 is a side elevation view of an article having a no-slip surface formed from a static cling material having a surface for increasing the surface coefficient of friction formed thereon using the process of FIG. 2.

### DETAILED DESCRIPTION OF THE INVENTION

The present invention is directed to an article having a no-slip surface or surface treatment and a method of applying the surface or the surface treatment to the article. Although specific embodiments of the invention will now be described with reference to the drawings, it should be understood that such embodiments are by way of example only and merely illustrative of but a small number of the many possible specific embodiments which can represent applications of the principles of the invention. Various changes and modifications obvious to one skilled in the art to which the invention pertains are deemed to be within the spirit, scope and contemplation of the invention as further defined in the appended claims.

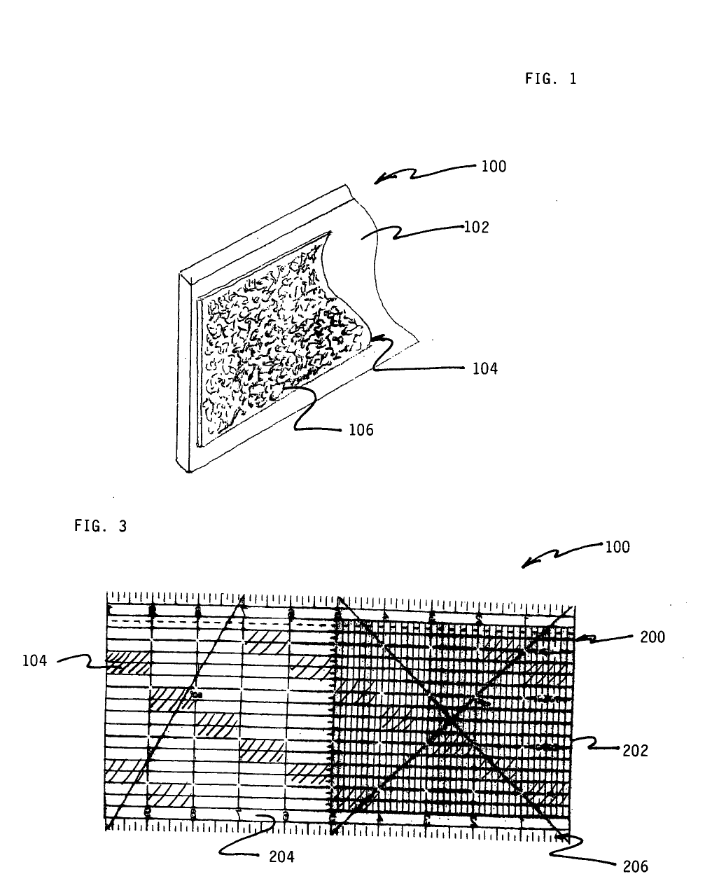

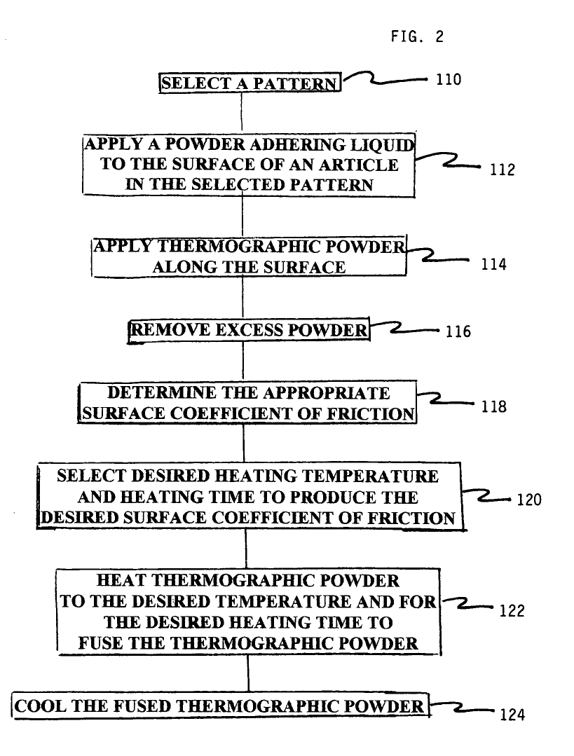

Referring to FIGS. 1, and 2, an article 100 is shown having a surface which operates as a substrate 102 for receiving a no-slip surface 104 or surface treatment. In a preferred embodiment of the invention, the no-slip surface 104 is formed from a conventional thermographic powder 106, such as a granular thermoplastic resin, which is deposited along the substrate 102. The powdered substrate 102 is then subjected to heat sufficient to melt the powder 106 and adhere it onto the substrate 102.

Thermography is an established printing process and typically involves depositing particles of thermographic powder on a thin sheet or film material that has a powder adhering liquid, such as an ink, glue, and the like, which can be of any color including clear, placed thereon in the form of a pattern or a printed image. The powder has the characteristic of melting under the effect of heat and of forming, after fusion, a film or a relief. Excess powder is removed, such as by suction or by air blast, to be recycled and the sheet or film material is then subjected to heat that fuses the powder adhering to the ink to the sheet of film material. After the powder is fused onto the sheet or film material, it is then cooled by passing through a cooler or by use of a blast of cool air which chills and solidifies the powder. Such suitable thermography processes and apparatus for placing powder adhering liquid in a selected pattern on a thin sheet or film material, depositing a thermographic powder thereon, and for heating and cooling the sheet or film material and powder are well known to those of ordinary skill in the art. However, until now, such apparatus and processes have not been used for forming a no-slip surface or applying a no-slip surface treatment to the surface of an article.

As shown in FIGS. 1 and 2, the thermographic process of the present invention begins with the step of selecting a pattern (step 110) and applying powder adhering liquid 108 (step 112) in a preselected pattern along the substrate 102. The adhering liquid 108 is formulated to adhere to various substrate materials, such as plastics, like acyclic, acrylonitrile-butadiene-styrene, polycarbonates, and poly vinyl chlorides. One such adhering liquid is a multi-purpose thermographic ink such as sold under the trademark ZEPHYR JET No. 9000 by Summit Inks Corporation of Kansas City, Mo. Other adhering liquids, such as a fast drying thermographic enamel, such as sold by Sericol Inks of Kansas City, Mo, or a glue adhesive such as sold by Southern Adhesives and Coatings, Cincinnati, Ohio under product no. DC1810, may also be used. The adhering liquid 108 is applied in a preselected pattern using a conventional silk screen process. The substrate 102 is then passed under a shaker (not shown) or other similar device (step 114) that deposits and agitates a quantity of thermographic powder 106 over the substrate 102 which adheres to the powder adhering liquid 108. The thermographic powder 106 is a powder conventionally used for thermographic printing and can be an opaque powder, such as a metallic powder or a pigmented powder, or a transparent powder or a colored transparent powder. Excess powder 106 is then removed (step 116) using a convention process such as by suction or by air blast, to be recycled. The desired surface coefficient of friction (step 118) and the appropriate heating temperature and time (step 120) are selected and the substrate 102 is then passed through a conventional heating apparatus (not shown), such as a tunnel-type oven, where it is heated (step 122) to melt or soften and fuse the thermographic powder 106 onto the substrate 102. The substrate 102 and the fused thermographic powder 106 are then cooled (step 124) to reduce the likelihood of smearing the fused powder 106.

The fusing of the thermographic powder 106 to the substrate 102 is a critical part of the no-slip surface treatment. By selecting the appropriate amount of heat and the appropriate length of heating time, the resulting roughness of the no-slip surface can be varied to produce the desired surface coefficient of friction. For example, by reducing the heat and/or the amount of heating time to melt or soften and fuse the thermographic powder, the roughness and the corresponding surface coefficient of friction can be increased. By increasing the heat and/or the length of heating time to melt and fuse the thermographic powder, the corresponding surface coefficient of friction can be reduced. It should be understood that the specific combination of heat and time for a given application can be easily determined by one skilled in the art.

It should now be apparent to those skilled in the art that the no-slip surface and surface treatment of the present invention can be used for a large variety of applications including, but not limited to, containers, flooring, table tops, bathroom fixtures, such as tubs, shower stalls, and the like, trays, coasters, tray supports, tools, measuring devices, and instruments.

Referring to FIG. 3, the article 100, as shown, is a measuring device 200 having a substantially thin and elongated planar shaped body 202 constructed preferably of a durable plasticized material having an upper face (not shown) and a lower face 204. The measuring device includes measurement indications 206 which may be printed on either the upper face or the lower face 204 or incorporated within the body 202. The lower face 204 operates as a substrate for receiving a no-slip surface 104, such as previously described herein, applied in a selected pattern to enable the user to maintain the measuring device 200 against the surface of the material or object being measured. It should now be understood to those skilled in the art that the use of a transparent powder adhering liquid and thermographic powder provides a no-slip surface that is transparent thereby not obstructing view of the user.

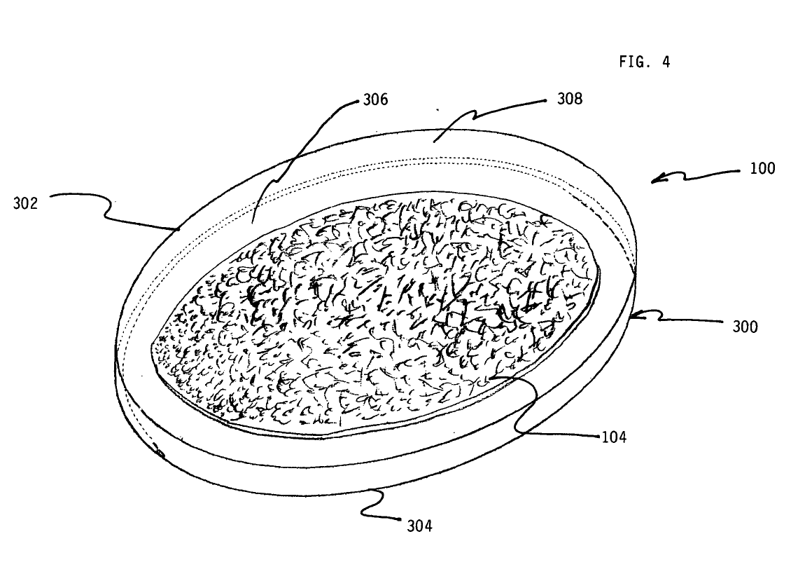

Referring to FIG. 4, the article 100, as shown, is a coaster or tray 300 generally comprising a rounded base 302 having an upper 304 and a lower face 306 and a vertical projection or wall 308. The lower face 306 operates as a substrate for receiving a no-slip surface 104, such as previously described herein, which operates to prevent or hinder the coaster or tray from sliding along the surface of a support (not shown). It should now be understood to those skilled in the art that the no-slip surface can be applied to the surface of the coaster or tray in a selected pattern and color to provide a no-slip surface as well as a decorative appearance. It should also be understood that the no-slip surface can also be transparent so that it will not detract from the appearance of the coaster or tray.

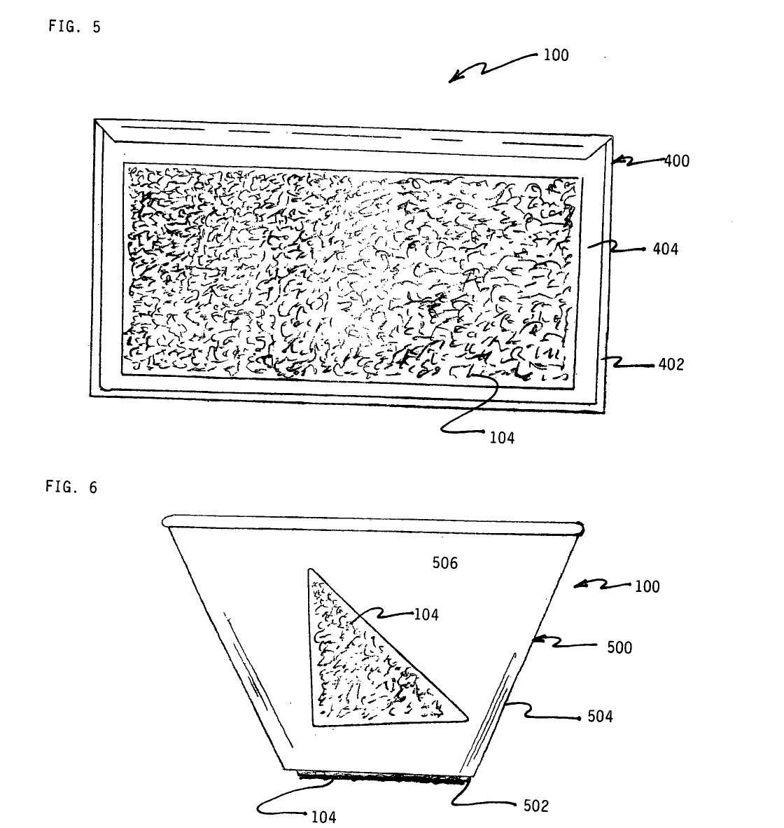

Referring to FIG. 5, the article 100, as shown, is a conventional tray support 400, such as conventionally used in passenger aircraft to support food trays, and generally comprises a rectangular base 402, having an upper 404 and a lower face (not shown).

The upper face 404 operates as a substrate for receiving a no-slip surface 104, such as previously described herein. The no-slip surface 104 operates to prevent or hinder food trays, glasses, beverage containers, and the like, from sliding along the upper face 404 of the tray support 400.

Referring to FIG. 6, the article 100, as shown, is a container 500, such as a beverage or food container, and comprises a bottom surface 502 and at least one vertically extending wall 504 having an outer face 506. The bottom surface 502 and the outer face 506 of the vertically extending wall 504 provide substrates for receiving a no-slip surface 104, such as previously described herein. It should be understood that the no-slip surfaces 104 can be used to reduce the likelihood that the container will slide along the support surface, such as when the support surface is not level, or slip out of the hand of a user when being held. It should now be understood to those skilled in the art that the no-slip surface can be applied to the surface of the container in a selected pattern and color to provide a no-slip surface as well as a decorative appearance. It should also be understood that the no-slip surface can also be transparent so that it will not detract from the appearance of the container.

It should now be apparent that the no-slip surface of the present application can be used for a wide variety of articles including, but not limited to measuring devices, flooring, bathroom fixtures, such as tubs, shower stalls and the like, containers, trays, tray supports, tools, and instruments.

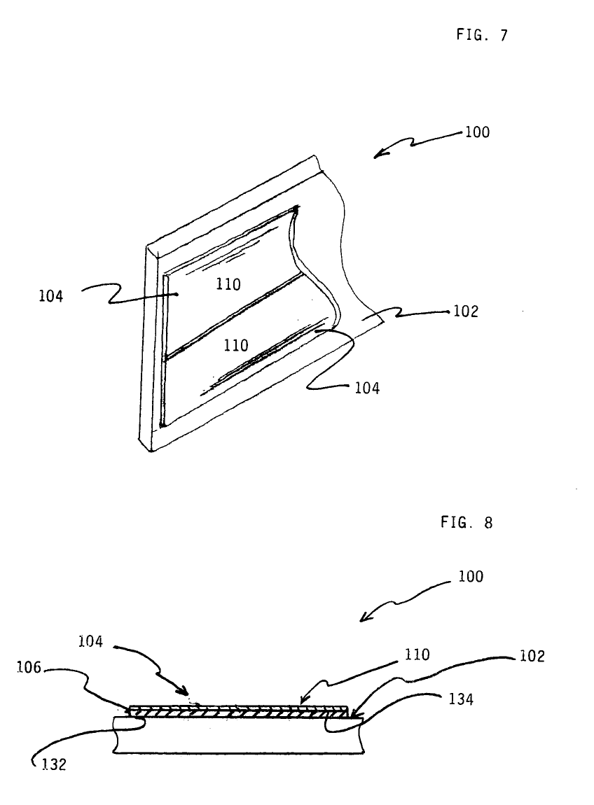

Referring to FIG. 7, another preferred embodiment of the invention is shown and comprises an article 100 having a surface for receiving a no-slip surface 104 comprising a conventional “static cling” plastic material 110. The static cling material 110 can be opaque or transparent and can be in a variety of colors. It should be understood that the term “static cling material” as used herein refers to a variety of well-known materials that are conventionally known as a “static cling material” but requires no adhesives and further adhesion is not based on static electricity but rather relies on a pressure-sensitive film such as a plasticized vinyl film. Such material is available from Cincinnati Cordage and Paper Co. in Cincinnati, Ohio and identified as Matte Clear TC Vinyl with a MR 861 Special Removable with 80# White Craft release liner. It should also now be understood that the use of such static cling material 110 provides a removable no-slip surface 104 effective for use on a variety of articles.

The static cling material 110 can be placed along the surface 102 of the article 100 in the form of a plurality of dots or static cling pieces, strips, or sheets. Depending on the particular article, the static cling material 110 may cover a substantially large portion of the article 100 or a relatively small portion of the article 100. As illustrated in FIG. 7, the static cling material 110 is shown applied onto a relatively flat surface 102 of the article 100 such as a conventional ruler, to cover a substantial portion of the surface 102. It has been found that for certain articles 100, such as rulers, by sizing the static cling material 110 slightly smaller than the surface 102 to form a small boundary 130 along the outer circumference of the surface 102 will prevent or reduce the likelihood of the static cling material 110 forming the no-slip surface 104 from peeling back or snagging during use thereby reducing manufacturing cost and the need for accurate alignment.

In another preferred embodiment of the invention, as shown in FIG. 8, an article 100 is shown having a no-slip surface 104 thereon. The no-slip surface includes a sheet of static cling material 110 having a first surface 132 for attaching to the article 100 and a second surface 134 for receiving a thermographic powder 106 applied, such as previously described herein (see FIG. 2), thereon to form the no-slip surface. The static cling material 110 can be applied to the surface 102 of an article 100, such as a ruler, contained, or the like. It has been found that using the static cling material 110 in combination with the no-slip surface previously described forms a combination no-slip surface having improved the coefficient of friction compared to other static cling materials, and produces a no-slip surface that can be easily removed or re-positioned.

It should now be apparent to those skilled in the art that the present invention provides a no-slip surface or surface treatment for an article that can provide a non-slip coefficient of friction, that can be permanently or removably attached to the article, that can be clear or transparent, that is easily applied, does not detrimentally detract from the appearance of the article, and which is relatively cost effective for most applications.

I claim:

1. An article having a removable no-slip surface formed from a static cling material.

2. The article of claim 1 wherein said no-slip surface is applied onto at least one surface of the article and wherein said no-slip surface is slightly smaller than said surface of the article.

3. The article of claim 1 wherein said no-slip surface is formed in a selected pattern.

4. The article of claim 1 wherein said no-slip surface includes a static cling material having a thermographic powder fused thereon.

5. The article of claim 1, wherein said article is selected from the group consisting of measuring devices, flooring, bathroom fixtures, counter tops, table tops, containers, trays, tray supports, tools, and instruments.

6. The article of claim 1 wherein said no-slip surface is transparent.

7. The article of claim 1 wherein said no-slip surface is a colored surface.

8. A method of applying a no-slip surface to an article comprising the steps of:
selecting a static cling material;
applying a thermographic powder along one surface of the static cling material; and
heating the thermographic powder to fuse the thermographic powder to the surface of the static cling material to form a no-slip surface.

9. The method of claim 8 further comprising the steps of:
sizing the static cling material for providing the desired size and configuration of the no-slip surface;
cutting the static cling material into the desired size and configuration; and
applying the static cling material to the article.

10. The method of claim 8 wherein the thermographic powder forms a transparent no-slip surface.

11. The method of claim 8 wherein the thermographic powder forms a colored no-slip surface.

12. The method of claim 8 wherein the article is a measuring device.

13. The method of claim 8 wherein the article is a ruler for use in measuring fabric for cutting.

14. The method of claim 8 wherein the article is a container.

15. The method of claim 8 wherein the article is a tray.

16. The method of claim 8 wherein the article is flooring.

17. The method of claim 8 further comprising the step of selecting the roughness of the no-slip surface which produces the desired surface coefficient of friction and heating the thermographic powder to the proper temperature and for the proper amount of time to form the no-slip surface having the desired surface coefficient of friction.

18. An article having a no-slip surface thereon, the article comprising:
static cling material having a first surface for attaching to the article and a second surface;
a powder adhering liquid applied in the selected pattern along said second surface;
a thermographic powder applied such that it adheres to the powder adhering liquid; and
wherein said thermographic powder is fused to said second surface to form the no-slip surface.

19. The article of claim 16 wherein the thermographic powder has a selected roughness which produces the desired surface coefficient of friction.

20. The article of claim 16 wherein said article is selected from the group consisting of measuring devices, flooring, tubs, shower stalls, containers, trays, tray supports, tools, and instruments.
